(19) United States
(12) Patent Application Publication
(10) Pub. No.: US 2025/0222575 A1
(43) Pub. Date: Jul. 10, 2025

(54) FASTENER REMOVAL TOOL

(71) Applicant: SHIFUKANG INDUSTRIAL.CO., LTD., TAICHUNG CITY (TW)

(72) Inventor: Shang-Yuan HUANG, Taichung City (TW)

(21) Appl. No.: 18/404,564

(22) Filed: Jan. 4, 2024

(51) Int. Cl. B25B 27/18; B60B 29/00

(52) U.S. Cl. CPC B25B 27/18; B60B 29/00

(57) ABSTRACT

A fastener removal tool is provided, wherein the fastener removal tool includes: a collet including an outer inclined surface, the outer inclined surface including a first threaded section, a first end portion of the collet including an opening; and an outer sleeve including a through hole and an urging portion, the urging portion being located in the through hole, the urging portion including a second threaded section, the second threaded section being located in the through hole, the second threaded section being selectively screwed to the first threaded section, the collet being disposed through the through hole; wherein when the second threaded section is screwed to the first threaded section and the outer sleeve and the collet are relatively rotated, the outer inclined surface is urged and the first end portion of the collet is radially contracted.

### BACKGROUND OF THE INVENTION

### Field of the Invention

The present invention relates to a fastener removal tool.

### Description of the Prior Art

Many objects are connected by using fasteners. For example, wheels are securely mounted to a vehicle with fasteners such as bolts, anti-theft screws, or the like. The anti-theft screws are used to protect and prevent the wheels from being stolen, and need to be unlocked and detached by using a specific unlock key.

As the fastener is unfastened with too much torque for many times, the driving portion of the fastener will be worn and cannot be well engaged, making the removal tool unable to drive the fastener. In addition, the special-shaped drive head of the anti-theft screw which is damaged and stuck is difficult to remove. Moreover, if the specific unlock key is lost, the anti-theft screw cannot be removed.

In the above situations, a grinder is usually used to form multiple grooves in the driving head or cut off the driving head by welding; however, the wheel is easily damaged in those processes. Besides, to remove the fastener which is damaged and stuck, there is another way that a socket with a smaller size than the driving head is forced or impacted to be tightly fitted around the driving head. However, the aforementioned removal methods each have numerous steps and are time-consuming.

The present invention is, therefore, arisen to obviate or at least mitigate the above-mentioned disadvantages.

### SUMMARY OF THE INVENTION

The main object of the present invention is to provide a fastener removal tool which is configured to tightly clamp a fastener for removing the fastener.

To achieve the above and other objects, a fastener removal tool is provided, wherein the fastener removal tool includes: a collet including an outer inclined surface, the outer inclined surface including a first threaded section, a first end portion of the collet including an opening; and an outer sleeve including a through hole and an urging portion, the urging portion being located in the through hole, the urging portion including a second threaded section, the second threaded section being located in the through hole, the second threaded section being selectively screwed to the first threaded section, the collet being disposed through the through hole; wherein when the second threaded section is screwed to the first threaded section and the outer sleeve and the collet are relatively rotated, the outer inclined surface is urged and the first end portion of the collet is radially contracted.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of an exemplary embodiment of the present invention;

FIG. 2 is a breakdown drawing of an exemplary embodiment of the present invention;

FIG. 3 is a cross-sectional view of an exemplary embodiment of the present invention;

FIG. 4 is a drawing showing operation of an exemplary embodiment of the present invention;

FIG. 5 is a cross-sectional view of an outer sleeve according to an exemplary embodiment of the present invention; and

FIG. 6 is a drawing showing an application of a fastener removal tool of an exemplary embodiment of the present invention.

### DETAILED DESCRIPTION OF THE PREFERRED EMBODIMENTS

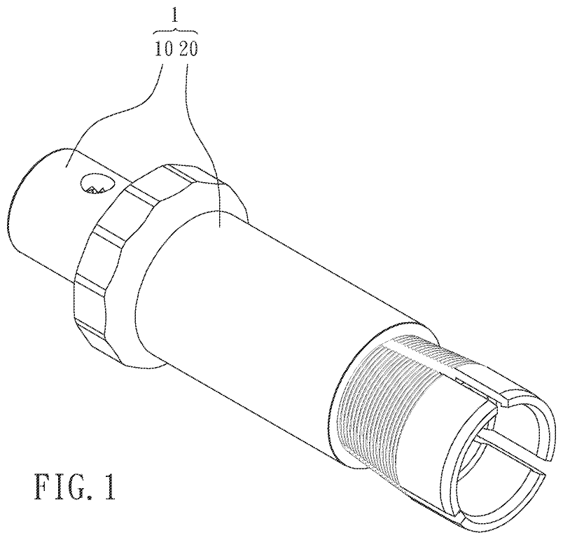

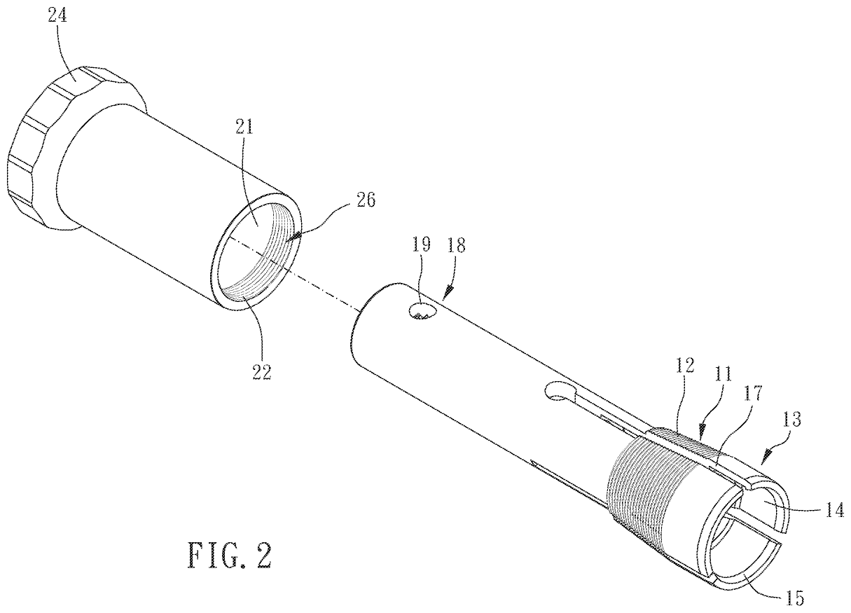

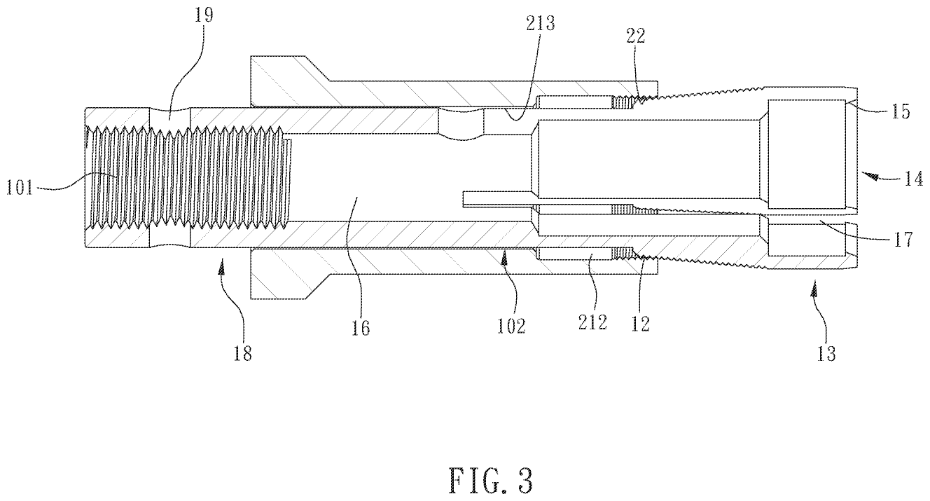

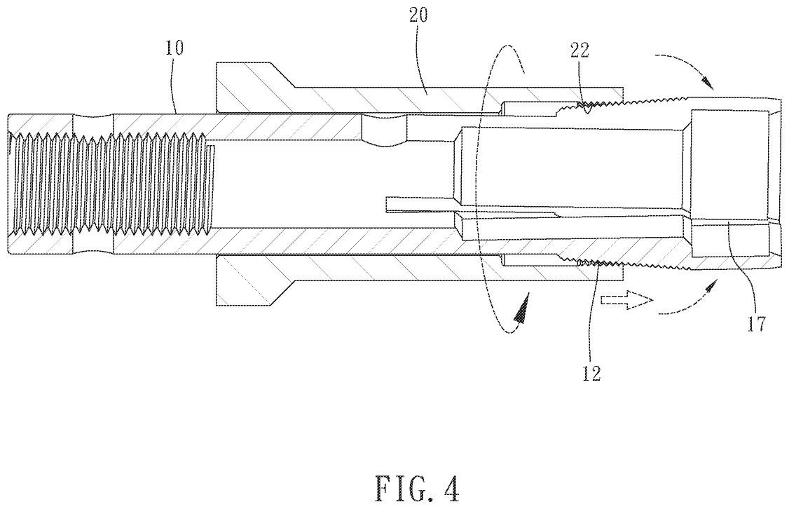

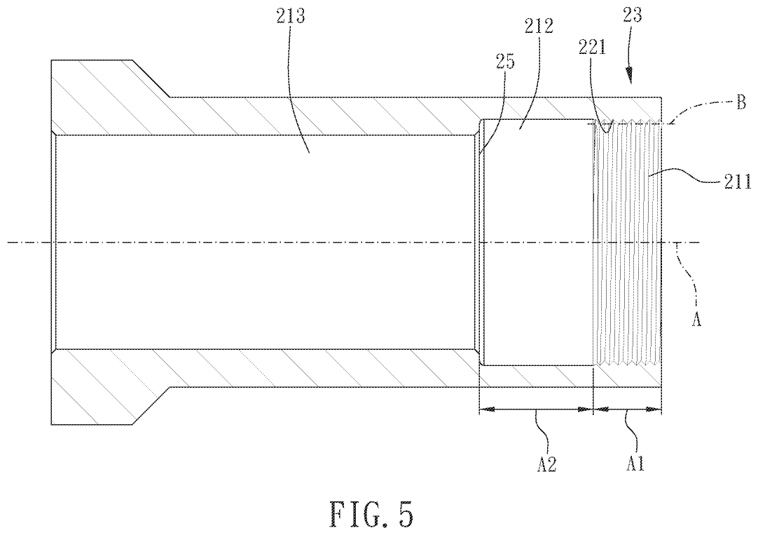

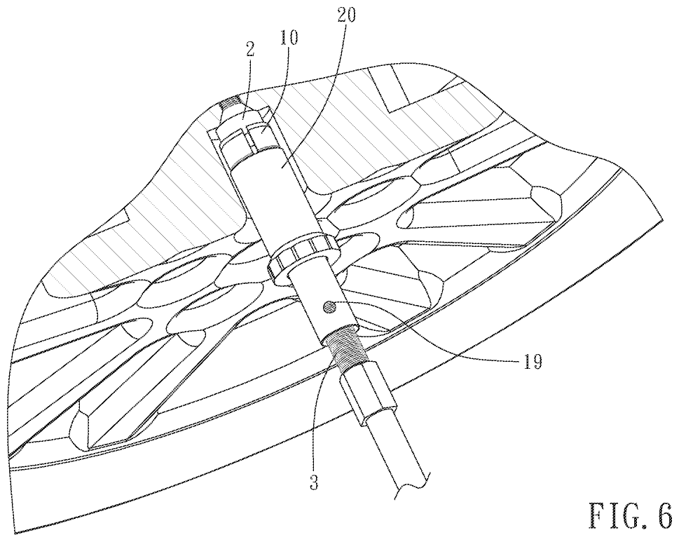

Please refer to FIGS. 1 to 6 for an exemplary embodiment of the present invention. A fastener removal tool 1 of the present invention includes a collet 10 and an outer sleeve 20.

The collet 10 includes an outer inclined surface 11, the outer inclined surface 11 includes a first threaded section 12, and a first end portion 13 of the collet 10 includes an opening 14. The first end portion 13 is configured to be sleeved on a fastener 2 (such as a bolt on a wheel or a fastener configured to connect two objects). The outer sleeve 20 includes a through hole 21 and an urging portion 26, the urging portion 26 is located in the through hole 21, the urging portion 26 includes a second threaded section 22, the second threaded section 22 is located in the through hole 21, the second threaded section 22 is selectively screwed to the first threaded section 12, the collet 10 is disposed through the through hole 21. When the second threaded section 22 is screwed to the first threaded section 12 and the outer sleeve 20 and the collet 10 are relatively rotated, the outer inclined surface 11 is urged (radially pressed by the urging portion 26) and the first end portion 13 is radially contracted and configured to clamp the fastener 2 for removing the fastener 2.

The outer inclined surface 11 is a conical surface tapered in a direction away from the opening.

The first end portion 13 further includes a flange 15 extending radially inward, and the flange 15 is configured to be engaged with the fastener 2. Specifically, the flange 15 can retain the peripheral portion of the fastener 2 received in the through hole 21, which is conducive to rotation and removal of the fastener 2.

The outer sleeve 20 further includes a knob 24 configured for users to rotate to drive the collet 10.

The collet 10 further includes an axial hole 16, the first end portion 13 further includes a plurality of slits 17 arranged in intervals, and the axial hole 16 is in communication with the plurality of slits 17 and the opening 14 so that the first end portion 13 can elastically deform radially to vary the diametric dimension of the opening 14. The axial hole 16 may be in communication with or not in communication with the plurality of slits 17, and the axial hole 16 is configured to receive the fastener 2.

A second end portion 18 of the collet 10 includes a perforation 19 disposed therethrough. In this embodiment, the axial hole 16 is in communication with the perforation 19; a shaft or pin may be inserted in the perforation 19 so that the shaft or pin can be moved to drive the collet 10 to rotate; and it allows observation inside the axial hole 16 through the perforation 19.

The collet 10 further includes an inner thread section 101 located in the axial hole 16. The inner thread section 101 is configured to be screwed with a threaded portion of a tool 3, and it allows observation on the connection state of the tool 3 with the inner thread section 101 through the axial hole 16. For example, the tool 3 is a puller, and the tool 3 can operate to drive the collet 10 to move axially.

The outer sleeve 20 defines an axial axis A and a reference line B, the second threaded section 22 includes a plurality of crests 221, the plurality of crests 221 extend around the axial axis A, the reference line B extends through apexes of at least two the plurality of crests 221, and the reference line B is parallel to the axial axis A, which is conducive to the radial contraction of the first end portion 13 in response to the pressing of the urging portion 26. The urging portion 26 extends in an axial direction parallel to the axial axis A.

The through hole 21 includes a first section 211 and a second section 212, the first section 211 is disposed on an end portion 23 of the outer sleeve 20, the second section 212 is next to the first section 211, the first section 211 includes the second threaded section 22, and the first section 211 has an inner diametric dimension smaller than an inner diametric dimension of the second section 212. Preferably, the second threaded section 22 has an axial dimension A1 smaller than an axial dimension A2 of the second section 212. As such, when the outer sleeve 20 is turned and adjusted, the second section 212 has a sufficient space for the outer inclined surface 11 with an increasingly larger outer diameter to pass without interfering with each other.

The through hole 21 further includes a third section 213, the third section 213 has an inner diametric dimension smaller than the inner diametric dimension of the first section 211 and the inner diametric dimension of the second section 212, and the second section 212 is located between the first section 211 and the third section 213. The collet 10 further includes a middle section 102, the middle section 102 is located between the first end portion 13 and the second end portion 18, the middle section 102 is inserted in the third section 213, and the inner diametric dimension of the third section 213 is larger than an outer diametric dimension of the middle section 102. In this embodiment, the second end portion 18 has an outer diametric dimension slightly smaller than the inner diametric dimension of the third section 213. As such, the second end portion 18 and the middle section 102 can pass through the through hole 21 smoothly, and can be supported on the third section 213 to avoid excessive deflection. The outer sleeve 20 further includes a shoulder 25 located in the through hole 21, and the shoulder 25 is located between the second section 212 and the third section 213.

In use, the first end portion 13 is configured to be sleeved on the fastener 2, the outer sleeve 20 is rotated so that the second threaded section 22 is screwed to the first threaded section 12 and the outer sleeve 20 moves axially relative to the collet 10, the outer inclined surface 11 is radially urged so that the first end portion 13 contracts radially to tightly clamp the fastener 2, and the tool 3 is screwed to the inner thread section 101 to drive the collet 10 to remove the fastener 2.

Although particular embodiments of the invention have been described in detail for purposes of illustration, various modifications and enhancements May be made without departing from the spirit and scope of the invention. Accordingly, the invention is not to be limited except as by the appended claims.

What is claimed is:

1. A fastener removal tool including:
a collet including an outer inclined surface, the outer inclined surface including a first threaded section, a first end portion of the collet including an opening; and
an outer sleeve including a through hole and an urging portion, the urging portion being located in the through hole, the urging portion including a second threaded section, the second threaded section being located in the through hole, the second threaded section being selectively screwed to the first threaded section, the collet being disposed through the through hole;
wherein when the second threaded section is screwed to the first threaded section and the outer sleeve and the collet are relatively rotated, the outer inclined surface is urged and the first end portion of the collet is radially contracted.

2. The fastener removal tool of claim 1, wherein the first end portion further includes a flange extending radially inward.

3. The fastener removal tool of claim 1, wherein the outer inclined surface is a conical surface tapered in a direction away from the opening.

4. The fastener removal tool of claim 1, wherein the collet further includes an axial hole, the first end portion further includes a plurality of slits arranged in intervals, and the axial hole is in communication with the opening.

5. The fastener removal tool of claim 1, wherein a second end portion of the collet includes a perforation disposed therethrough.

6. The fastener removal tool of claim 5, wherein the collet includes an axial hole, the axial hole in communication with the perforation.

7. The fastener removal tool of claim 6, wherein the collet further includes an inner thread section located in the axial hole.

8. The fastener removal tool of claim 1, wherein the outer sleeve defines an axial axis and a reference line, the second threaded section includes a plurality of crests, the plurality of crests extend around the axial axis, the reference line extends through apexes of at least two the plurality of crests, and the reference line is parallel to the axial axis.

9. The fastener removal tool of claim 8, wherein the through hole includes a first section and a second section, the first section is disposed on an end portion of the outer sleeve, the second section is next to the first section, the first section includes the second threaded section, and the first section has an inner diametric dimension smaller than an inner diametric dimension of the second section.

10. The fastener removal tool of claim 7, wherein the first end portion further includes a flange extending radially inward; the outer sleeve further includes a knob; the first end portion further includes a plurality of slits arranged in intervals, and the axial hole is in communication with the opening; the outer sleeve defines an axial axis and a reference line, the second threaded section includes a plurality of crests, the plurality of crests extend around the axial axis, the reference line extends through apexes of at least two the plurality of crests, and the reference line is parallel to the axial axis; the through hole includes a first section and a second section, the first section is disposed on an end portion of the outer sleeve, the second section is next to the first section, the first section includes the second threaded section, and the first section has an inner diametric dimension smaller than an inner diametric dimension of the second section; the through hole further includes a third section, the third section has an inner diametric dimension smaller than the inner diametric dimension of the first section and the inner diametric dimension of the second section, the second section is located between the first section and the third section, the collet further includes a middle section, the middle section is located between the first end portion and the second end portion, the middle section is inserted in the third section, and the inner diametric dimension of the third section is larger than an outer diametric dimension of the middle section; the outer sleeve further includes a shoulder located in the through hole, and the shoulder is located between the second section and the third section; the second threaded section has an axial dimension smaller than an axial dimension of the second section.
